(19) United States
(12) Patent Application Publication
(10) Pub. No.: US 2007/0192441 A1
(43) Pub. Date: Aug. 16, 2007

(54) Network system based on remote user interface protocol and method of operating server and client of network system, and computer-readable medium having embodied thereon computer program for executing method of operating server and client of network system

(75) Inventors: Ho Jin, Yongin-si (KR); Jung-yon Cho, Suwon-si (KR); Hyo-dae Kim, Yongin-si (KR); Tae-young Song, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/601,652

(22) Filed: Nov. 20, 2006

(30) Foreign Application Priority Data
Feb. 11, 2006 (KR) 10-2006-0013338
Feb. 14, 2006 (KR) 10-2006-0014249

(51) Int. Cl. G06F 15/16

(52) U.S. Cl. 709/219

(57) ABSTRACT

A network system based on a remote user interface (RUI) protocol, which can provide a virtual pointing device service and in which an RUI server and an RUI client can share an RUI service based on movement of a pointing device, and method of operating a server and a client of the network systems, and a computer-readable medium having embodied thereon a computer program for executing the method of operating the server and the client of the network systems. A network system includes: a plurality of clients; and a server which transfers pointing device user interface information to at least one of the clients if a request for providing a virtual pointing device service is transferred from the at least one of the clients.

### CROSS-REFERENCE TO RELATED PATENT APPLICATION

This application claims priority from Korean Patent Application Nos. 10-2006-0013338 and 10-2006-0014249, filed on Feb. 11, 2006 and Feb. 14, 2006, respectively, in the Korean Intellectual Property Office, the disclosure of which is incorporated herein in its entirety by reference.

### BACKGROUND OF THE INVENTION

1. Field of the Invention

Systems and methods consistent with the present invention relate to a network system such as a home network, and more particularly, to a network system based on a remote user interface (RUI) protocol and a method of operating a server and a client of the network system, and a computer-readable medium having embodied thereon a computer program for executing the method of operating a server and a client of the network system.

2. Description of the Related Art

An RUI protocol is used when digital media content is transferred between an RUI client and an RUI server in a network such as a home network based on universal plug and play (UPnP). The RUI client requests RUI information from the RUI server by using the RUI protocol. When RUI information is received from the RUI server, the RUI client displays a screen based on the received RUI information. Accordingly, a user can use a service provided by the RUI server through the screen displayed by the RUI client. The RUI client may be a digital television, a personal digital assistant (PDA), a printer, a camcorder, a digital camera, or an MP3 player connected to a home network. The RUI server may be the PDA, a portable multimedia player (PMP), or a personal computer (PC).

However, when the screen displayed by the RUI client is controlled by using a pointing device and the RUI client does not provide a pointing device function even when the RUI client can display the screen based on the received RUI information, the RUI client cannot use a service provided by the RUI server from the displayed screen.

For example, when the screen displayed by the RUI client is a web page through which content can be selected by using the pointing device and the RUI client does not support the pointing device function, the RUI client cannot select any content from the displayed web page.

Meanwhile, the RUI client provides an RUI service to the user by sharing RUI information provided by the RUI server.

When the RUI client and the RUI server support the pointing device function, the related art RUI client generates a pointing event whenever the user performs a selecting operation by using the pointing device, and transfers the generated pointing event and pointing location information corresponding thereto to the RUI server. If the user uses a mouse as the pointing device, the selecting operation is a click event of a mouse button. As a result, the RUI server provides RUI information based on the received pointing location information and pointing event information to the RUI client. In this manner, when the RUI client and the RUI server support the pointing device function, the RUI client provides the RUI service by sharing RUI information of the RUI server whenever the pointing event is generated.

However, RUI information of the RUI server, which supports the pointing device function, may further include RUI information based on the movements of the pointing device. For example, RUI information of the RUI server may include RUI information to provide a RUI service such as a roll over server or a highlight service.

On the other hand, the RUI client included in the network system based on the conventional RUI protocol does not generate an event based on movements of the pointing device. Thus, while the pointing device moves in the RUI client, information is not transferred from the RUI client to the RUI server. Accordingly, even if the RUI server has RUI information based on moving of the pointing device, the RUI client cannot share RUI information. Therefore, the RUI client cannot provide the user with the RUI service based on movements of the pointing device, which is supported by the RUI server.

### SUMMARY OF THE INVENTION

The present invention provides a network system based on a RUI protocol that can provide a virtual pointing device service, a method of operating a server and a client of the network system, and a computer-readable medium having embodied thereon a computer program for executing the method of operating a server and a client of the network system.

The present invention also provides an RUI server and an RUI client that can provide a virtual pointing device service in a network system based on an RUI protocol.

The present invention also provides a network system based on an RUI protocol, in which an RUI service based on movements of a pointing device can be shared between an RUI client and an RUI server, a method of operating a server and a client of the network system, and a computer-readable medium having embodied thereon a computer program for executing the method operating a server and a client of the network system.

The present invention also provides an RUI server and an RUI client that can share an RUI service based on movements of a pointing device.

According to an aspect of the present invention, there is provided a network system based on a remote user interface protocol, comprising: one or more clients; and a server which transfers pointing device user interface information to at least one of the clients when a request for providing a virtual pointing device service is transferred from the at least one of the clients.

According to another aspect of the present invention, there is provided a network system based on a remote user interface protocol, comprising: a plurality of clients; and a server which transfers pointing device user interface information to at least one of the clients when a request for providing a virtual pointing device service is transferred from the at least one of the clients.

According to another aspect of the present invention, there is provided a server for providing a virtual pointing device service in a network system based on a remote user interface protocol including a plurality of clients, the server comprising: a user interface information generating unit which generates at least pointing device user interface information; a communication unit which is used for communication between at least one of the clients and the server; and a control unit which controls the user interface information generating unit to generate pointing device user interface information, and transfers the generated pointing device user interface information to the communication unit, when a request for providing the virtual pointing device service is received from the communication unit.

According to another aspect of the present invention, there is provided a client which can provide a virtual pointing device service in a network system based on a remote user interface protocol including a server which can provide the virtual pointing device service, the client comprising: a command receiving unit which receives a user command; a communication unit which is used for communication between the server and the clients; a display unit which displays a pointing device user interface screen based on pointing device user interface information; and a control unit which transfers a request for providing the virtual pointing device service to the communication unit, and controls the display unit to display the pointing device user interface screen when pointing device user interface information is received from the communication unit.

According to another aspect of the present invention, there is provided a method of operating a server for a virtual pointing device service in a network system including a server and a plurality of clients, the method comprising: transferring pointing device user interface information to at least one of the clients when a request for providing a virtual pointing device service is received from the at least one of the clients; updating location information of a pointing device based on pointing information whenever pointing information is received from the at least one of the clients; and generating pointing device user interface information based on updated location information of the pointing device, and transfers the generated pointing device user interface information to the at least one of the clients, whenever location information of the pointing device is updated.

According to another aspect of the present invention, there is provided a method of operating a client for a virtual pointing device service in a network system including a server and a plurality of clients, the method comprising: transferring a request for providing a virtual point device service to the server; displaying a screen in which pointing device user interface information is overlaid with remote user interface information when pointing device user interface information is received from the server; transferring a command to the server when the command is input based on the displayed screen; and displaying user interface information received from the server based on the input command.

According to another aspect of the present invention, there is provided a computer-readable medium having embodied thereon a computer program for executing a method of operating a server for a virtual pointing device service in a network system including a server and a plurality of clients, the computer-readable medium comprising: a code for transferring pointing device user interface information to at least one of the clients when a request for providing a virtual pointing device service is received from the at least one of the clients; a code for updating location information of a pointing device based on pointing information whenever pointing information is received from the at least one of the clients; and a code for generating pointing device user interface information based on updated location information of the pointing device, and for transferring the generated pointing device user interface information to the at least one of the clients, whenever location information of the pointing device is updated.

According to another aspect of the present invention, there is provided a computer-readable medium having embodied thereon a computer program for executing a client operation method for a virtual pointing device service in a network system including a server and a plurality of clients, the computer-readable medium comprising: a code for transferring a request for a providing a virtual pointing device service to the server; a code for displaying a screen in which pointing device user interface information is overlaid with remote user interface information when pointing device user interface information is received from the server; a code for transferring a command to the server when the command is input based on the displayed screen; and a code for displaying user interface information received from the server based on the input command.

According to another aspect of the present invention, there is provided a network system based on a remote user interface protocol, comprising: a plurality of clients; and a server which generates remote user interface information based on a pointing device moving event and corresponding location information, and transfers the generated remote user interface information to at least one of the clients, when the pointing device moving event and location information corresponding thereto are received from the at least one of the clients.

According to another aspect of the present invention, there is provided a server which can provide a remote user interface service in a network system based on a remote user interface protocol including a plurality of clients, the server comprising: a user interface information generating unit which generates remote user interface information; a communication unit which is used for communication between at least one of the clients and the server; and a control unit which controls the remote user interface information generating unit to generate remote user interface information based on the pointing device moving event, and transfers the generated remote user interface information to the communication unit, when the pointing device moving event and location information corresponding thereto are received from the communication unit.

According to another aspect of the present invention, there is provided a client which can provide a remote user interface service in a network based on a remote user interface protocol including a server which can provide the remote user interface service, the client comprising: a pointing device; a communication unit which is used for communication between the server and the client; a display unit which displays a remote user interface screen; a pointing device handler which monitors the pointing device and generates a pointing device moving event; and a control unit which transfers the pointing device moving event and location information corresponding thereto to the server through the communication unit when the pointing device moving event is generated from the pointing device handler, and controls the display unit to display the remote user interface screen based on remote user interface information when remote user interface information is received from the server.

According to another aspect of the present invention, there is provided a method of operating a server for a remote user interface service in a network system including a server and a plurality of clients, the method comprising: generating remote user interface information based on a pointing device moving event and corresponding location information when the pointing device moving event is received from at least one of the clients; and transferring the generated remote user interface information to the at least one of the clients.

According to another aspect of the present invention, there is provided a method of operating a client for a remote user interface service in a network system including a server and a plurality of clients, the method comprising: transferring a pointing device moving event and location information corresponding thereto to the server when the pointing device moving event of the client is generated, and displaying remote user interface information based on the received remote user interface information when remote user interface information is received from the server.

According to another aspect of the present invention, there is provided a computer-readable medium having embodied thereon a computer program for executing a server operation method for a remote user interface service in a network system including a server and a plurality of clients, the computer-readable medium comprising: a code for generating remote user interface information based on a pointing device moving event and corresponding location information when the pointing device moving event is received from at least one of the clients; and a code for transferring the generated remote user interface information to the at least one of the clients.

According to another aspect of the present invention, there is provided a computer-readable medium having embodied thereon a computer program for executing a client operation method for a remote user interface service in a network system including a server and a plurality of clients, the computer-readable medium comprising: a code for transferring a pointing device moving event and corresponding location information to the server when the pointing device moving event of the client is generated, and a code for displaying remote user interface information based on the received remote user interface information when remote user interface information is received from the server

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a network system according to an exemplary embodiment of the present invention;

FIG. 2 is a block diagram of a server of the network system of FIG. 1, according to an exemplary embodiment of the present invention;

FIG. 3 is a block diagram of the first to nth clients of the network system of FIG. 1, according to an exemplary embodiment of the present invention;

FIG. 4 is a screen including virtual pointing device service on/off selection information displayed by a client according to an exemplary embodiment of the present invention;

FIG. 5 is an example of a data format for data transferred from a client to a server, according to an exemplary embodiment of the present invention;

FIG. 6 is an example of a data format for data transferred from a server to a client, according to an exemplary embodiment of the present invention;

FIG. 7 is a block diagram showing an another example of the server of the network system of FIG. 1;

FIG. 8 is a flowchart illustrating a method of operating a server according to an exemplary embodiment of the present invention;

FIG. 9 is a flowchart illustrating a method of operating a client according to an exemplary embodiment of the present invention;

FIG. 10 is a flowchart illustrating a method of operating a server according to another exemplary embodiment of the present invention;

FIG. 11 is a flowchart illustrating a method of operating a server according to another exemplary embodiment of the present invention;

FIGS. 12A and 12B are flowcharts illustrating a method of operating a client according to another embodiment of the present invention;

FIG. 13 is a block diagram showing another example of the server of the network system of FIG. 1;

FIG. 14 is a block diagram of another example of the first to nth clients of the network system of FIG. 1;

FIG. 15 is a data format for data transferred from a client to a server, according to an embodiment of present invention;

FIG. 16 is a block diagram showing another example of the first to nth clients of the network system of FIG. 1;

FIG. 17 is a flowchart illustrating a method of operating a server according to another embodiment of the present invention;

FIG. 18 is a flowchart illustrating a method of operating a client according to another embodiment of the present invention;

FIG. 19 is a flowchart illustrating a method of operating a server according to another embodiment of the present invention;

FIG. 20 is a flowchart illustrating a method of operating a client according to another embodiment of the present invention; and

FIG. 21 is a flowchart illustrating a method of operating a server according to another embodiment of the present invention.

### DETAILED DESCRIPTION OF EXEMPLARY EMBODIMENTS OF THE INVENTION

Hereinafter, the present invention will be described in detail by explaining exemplary embodiments of the invention with reference to the attached drawings.

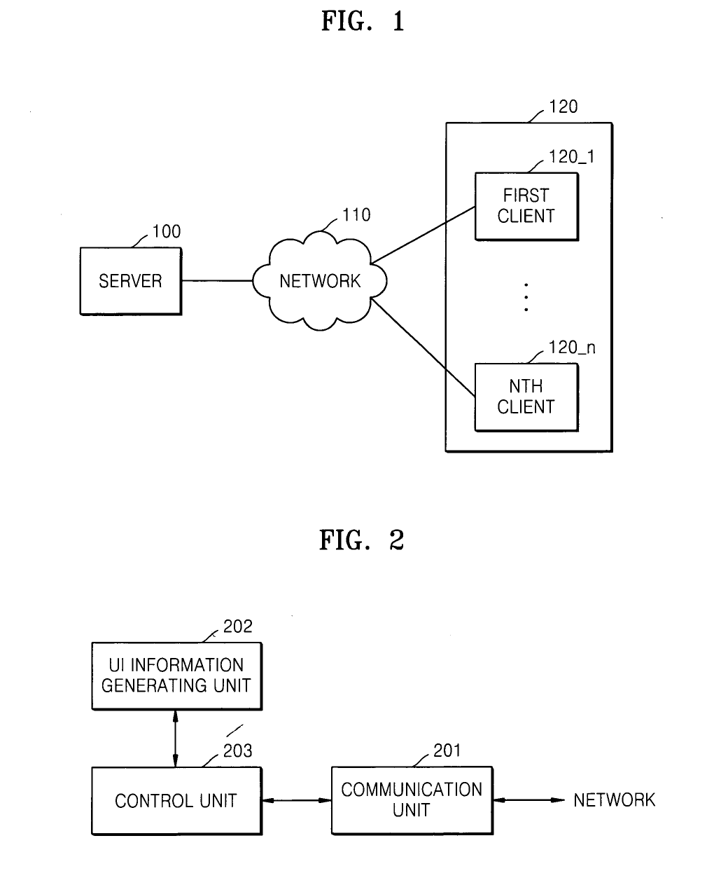

FIG. 1 illustrates a block diagram of a network system according to an exemplary embodiment of the present invention.

Referring to FIG. 1, the network system includes a server 100, a network 110, and a client group 120.

The server 100 supports a virtual pointing device service to at least one of the clients included in the client group 120 connected through the network 110.

When the server 100 and at least one of the clients included in the client group 120 are connected through the network 110, the server 100 and the client connected to the server 100 share their profiles. The connection between the server 100 and the client group 120 may be performed in the client group 120 by using a uniform resource locator (URL) of the server 100 or a uniform resource identifier (URI) of the server 100. By sharing the profiles between the server 100 and the client connected to the server 100, the server 100 can recognize a condition of an operation of the client connected to the server 100, and the client connected to the server 100 can recognize a history of the services provided by the server 100.

After the profiles between the server 100 and the client connected to the server 100 are shared, the server 100 may transfer on/off selection information on a virtual pointing device service to the client connected to the server 100. That is, by sharing the profiles between the server 100 and the client connected to the server 100, if it is determined that the server 100 can support a virtual pointing device service and the client connected to the server 100 can support the virtual pointing device service but cannot support a pointing device function, the server 100 may transfer virtual pointing device service on/off selection information to the client connected to the server 100.

When RUI information based on an RUI protocol has already been transferred to the client connected to the server 100 or when RUI information is being transferred to the client connected to the server 100, the server 100 may transfer virtual pointing device service on/off selection information to the client connected to the server 100. That is, after sharing the profiles between the server 100 and the client 120, the server 100 may transfer RUI information based on the RUI protocol to the client connected to the server 100 before or when virtual pointing device service on/off selection information is being transferred to the client connected to the server 100. The RUI information may be transferred in the form of an image file having a web page format used in a personal computer (PC) or a personal data assistant (PDA).

The client group 120 includes the first to nth clients 120_1 to 120_{—}n. The first to nth clients 120_1 to 120_{—}n include various devices capable of displaying RUI information, for example, the PDA, a multifunction printer, a camcorder, a digital still camera (DSC), an MP3 player, or a digital TV. The client connected to the server 100 may be at least one of the client group 120_1 to 120_{—}n included in the client group 120. That is, the client connected to the server 100 may correspond to all, some, or any one of the first to nth clients 120_1 to 120_{—}n.

Accordingly, all, some, or any one of the first to nth clients 120_1 to 120_{—}n may be connected to the server 100 so as to receive the virtual pointing device service.

When a user of the client connected to the server 100 selects “on” for the virtual pointing device service, the server 100 receives a request for providing the virtual pointing device service from the client connected to the server 100.

When the request for providing the virtual pointing device service is transferred from the client connected to the server 100, the server 100 generates pointing device user interface (UI) information, and transfers the generated pointing device UI information to the client connected to the server 100.

Thereafter, whenever pointing information is received from the client connected to the server 100, the server 100 updates location information of the pointing device based on the received pointing information. In addition, whenever location information of the pointing device is updated, the server 100 generates pointing device UI information based on the updated location information of the pointing device, and transfers the generated pointing device UI information to client connected to the server 100.

When information is received from the client connected to the server 100, the server 100 can determine whether the received information is pointing information. If the received information is determined to be pointing information, the server 100 performs the aforementioned operation based on the received pointing information. Otherwise, the server 100 performs an operation based on the received information. If the received information indicates that there is a need for updating RUI information, the server 100 updates RUI information based on the received information, and transfers the updated RUI information to the client connected to the server 100.

When the client connected to the server 100 requests disconnection, the server 100 ends a virtual pointing device service function for the client connected to the server 100.

In order to carry out the aforementioned operations, the server 100 may have a structure of FIG. 2. FIG. 2 is a block diagram of the server 100 of the network system of FIG. 1, according to an exemplary embodiment of the present invention. Referring to FIG. 2, the server 100 includes a communication unit 201, an UI information generating unit 202, and a control unit 203.

The communication unit 201 sends or receives information between at least one of the first to nth clients 120_1 to 120_{—}n and the server 100. The UI information generating unit 202 generates pointing device UI information. The UI information generating unit 202 may generate not only pointing device UI information but also RUI information.

After the server 100 and the client connected to the server 100 share their profiles, the control unit 203 transfers virtual pointing device service on/off selection information to the client connected to the server 100 through the communication unit 201. Before or when virtual pointing device service on/off selection information is transferred to the communication unit 201, the control unit 203 may transfer RUI information based on the RUI protocol to the client connected to the server 100.

Thereafter, when a request for providing the virtual pointing device service is received from the communication unit 201, the control unit 203 controls the UI information generating unit 202, thereby generating the pointing device UI information. The control unit 203 transfers the generated pointing device UI information to the communication unit 201.

Whenever pointing information is received from the client connected to the server 100, the control unit 203 updates location information of the pointing device based on the received pointing information. The control unit 203 generates pointing device UI information based on the updated location information of the pointing device, and transfers the generated pointing device UI information to the client connected to the server 100 through the communication unit 201.

When a disconnection request transferred from a client that supports the virtual pointing device service is received through the communication unit 201, the control unit 203 ends the virtual pointing device service function for the client.

The control unit 203 may generate a virtual pointing device service module when receiving a request for providing the virtual pointing device service, and perform the virtual pointing device service by using the generated virtual pointing device service module. If the disconnection request is received through the communication unit 201 when the virtual pointing device service is performed by using the generated virtual pointing device service module, the control unit 203 deletes the generated virtual pointing device service module.

Furthermore, when information is received from the client connected to the server 100, the control unit 203 determines whether the received information is pointing information. If the received information is determined to be pointing information, the control unit 203 performs a function based on the received pointing information. Otherwise, the control unit 203 performs a function based on the received information. The function based on the received information may include the RUI information update function of FIG. 1.

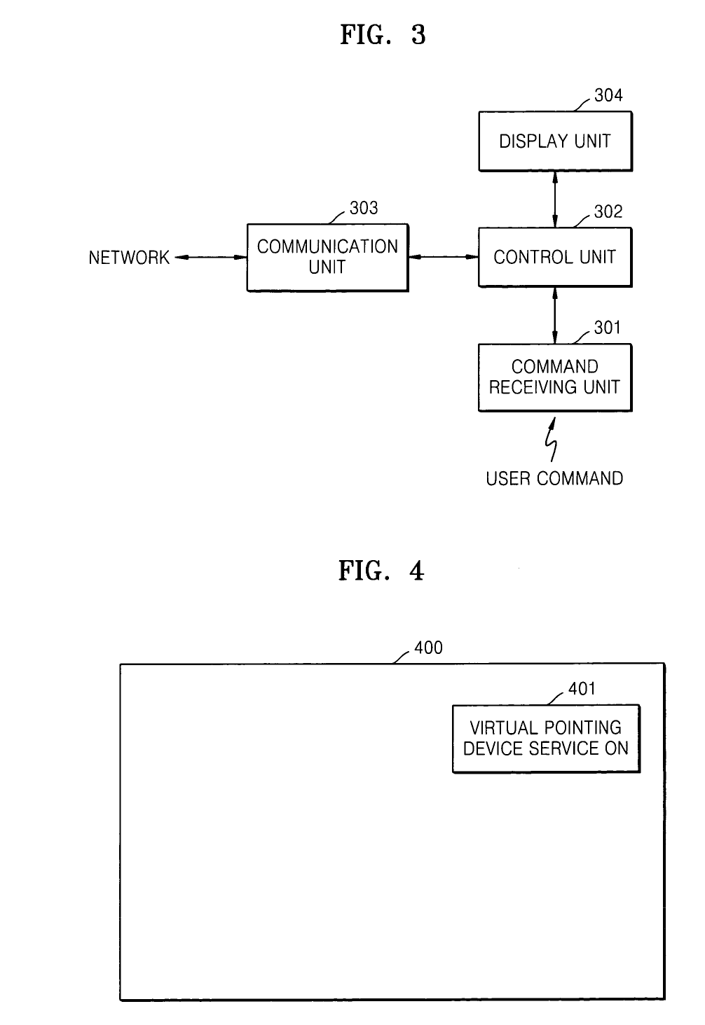

The client connected to the server 100 may have a structure of FIG. 3. Likewise, the first to nth clients 120_1 to 120_{—}n of FIG. 1 may have the structure of FIG. 3. FIG. 3 illustrates a block diagram of the first to nth clients 120_1 to 120 of the network system of FIG. 1, according to an exemplary embodiment of the present invention. Referring to FIG. 3, the client connected to the server 100 includes a command receiving unit 301, a control unit 302, a communication unit 303, and a display unit 304.

The command receiving unit 301 receives a user command. If the user command is input through a remote controller (not shown) for controlling functions of the client connected to the server 100, the command receiving unit 301 is composed of a remote control receiving unit. If the user command is input through buttons (not shown) disposed on a front panel placed in the client connected to the server 100, the command receiving unit 301 is composed of a device capable of generating a signal based on an operation of the buttons disposed on the front panel. If the user command is input through a touch panel installed in the client connected to the server 100, the command receiving unit 301 is composed of a device capable of detecting a sensing state of the touch panel. In addition, the command receiving unit 301 may receive the user command by using other input devices besides the pointing device.

The control unit 302 shares a profile with the server 100 when a corresponding client is connected to the server 100 through the network 110. As a result, when virtual pointing device service on/off selection information is received from the server 100 through the communication unit 303, the control unit 302 controls the display unit 304 to display virtual pointing device service on/off selection information.

For example, if the client connected to the server 100 is the first client 120_1, and the first client 120_1 is a digital TV, then virtual pointing device service on/off selection information may be displayed as shown in FIG. 4. FIG. 4 illustrates a screen illustrating virtual pointing device service on/off selection information displayed in the client according to an exemplary embodiment of the present invention. Referring to FIG. 4, 400 of FIG. 4 is the digital TV screen, and 401 is the virtual pointing device service on/off selection information. In FIG. 4, the virtual pointing device service on/off selection information is set to “on”. This means that a request for providing the virtual pointing device service has already been transferred by a user of the digital TV.

After the server 100 and the client connected to the server 100 have shared their profiles, the control unit 302 may receive RUI information from the server 100 through the communication unit 303 before or when receiving virtual pointing device service on/off selection information. When RUI information is received, the control unit 302 controls the display unit 304 to display a screen based on RUI information. In this case, the screen 400 of FIG. 4 is the screen based on RUI information.

If it is determined that the request for providing the virtual pointing device service is requested by the user based on information received from the command receiving unit 301, the control unit 302 transfers the request for providing the virtual pointing device service to the communication unit 303.

Thereafter, when pointing device UI information is received from the communication unit 303, the control unit 302 controls the display unit 304 to display a screen based on pointing device UI information. In this case, the control unit 302 controls the display unit 304 in order to display a screen on which pointing device UI information overlays with RUI information received before the virtual pointing device service on/off selection. The pointing device UI information may include an image file of pointing device UI information and location information of its pointer.

After pointing information is received from the command receiving unit 301 based on the screen including pointing device UI information displayed by the display unit 304, the control unit 302 transfers pointing information to the communication unit 303.

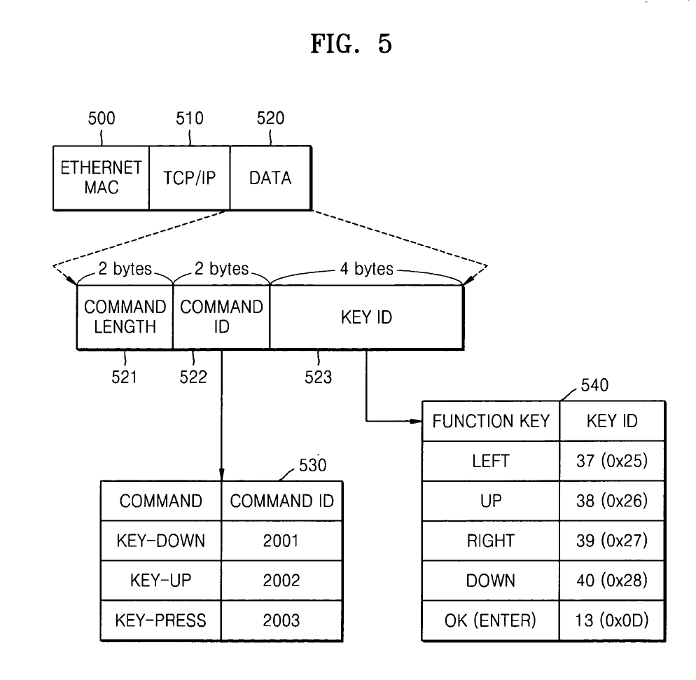

If the user inputs a user command by using a direction key and an enter key of a remote control, the control unit 302 may transfer pointing information having the format of FIG. 5 to the communication unit 303 based on the received information regarding the direction key and the enter key.

FIG. 5 illustrates an example of a data format for data transferred to the server 100 from the client connected to the server 100, according to an exemplary embodiment of the present invention. In FIG. 5, the data is transferred from the client, which is connected to the server 100, to the server 100 by using a transmission control protocol (TCP) based packet transfer method. This can be realized based on information defined in a field 500 and a field 510.

Referring to FIG. 5, each data field 520 includes a two-byte command length 521, a two-byte command ID 522, and a four-byte key ID 523. The two-byte command ID 522 may represent a key-down command, a key-up command, or a key-press command. The key-press command is defined as a state in which an up/down/left/right key is pressed. The key-down and the key-up commands are used for the server 100 to distinguish a continuous input value. The four-byte key ID 523 may be defined as information regarding the up/down/left/right key and the enter key. For example, in FIG. 5, if information for the two-byte command ID 522 is “2003” and the four-byte key ID 523 is “37” is transferred to the server 100, the server 100 recognizes that the left key is pressed.

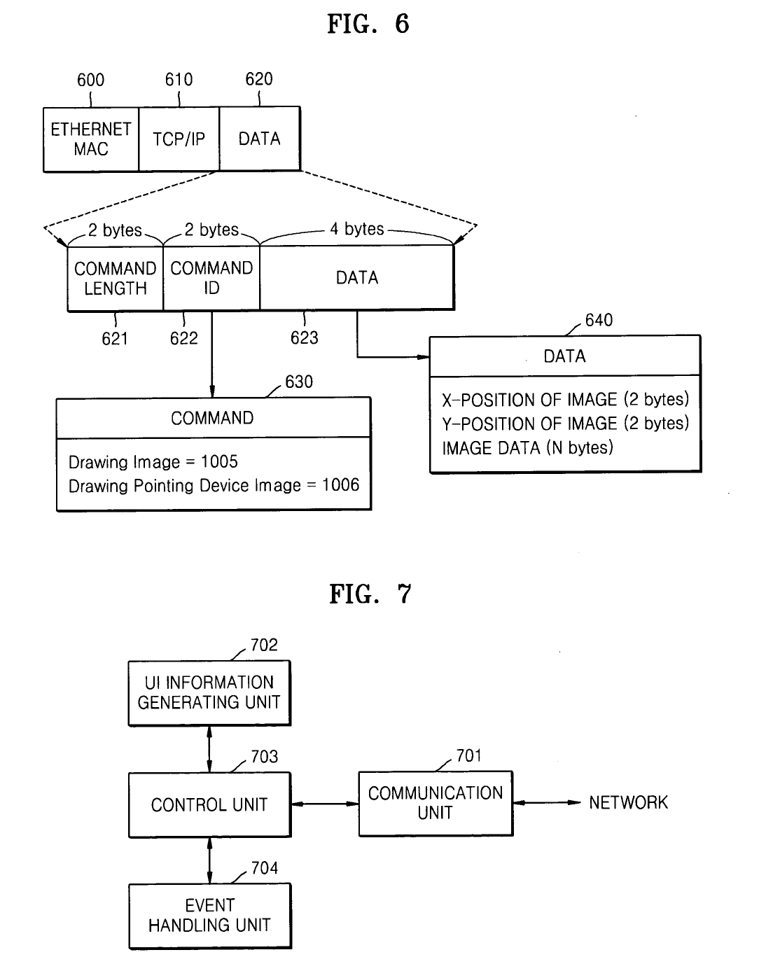

In response thereto, the server 100 may transfer pointing device UI information having a format of FIG. 6. FIG. 6 illustrates an example of a data format for data transferred from the server 100 to the client connected to the server 100, according to an embodiment of the present invention. In FIG. 6, an extended remote technology (XRT) packet is exemplified for the case of transferring RUI information and pointing device UI information. Referring to FIG. 6, each data field 623 includes a two-byte command length 621, a two-byte command ID 622, and (N+4) byte data 623. The two-byte command ID 622 includes information (Drawing Image=1005) indicating whether data currently being transferred is RUI information, and information (Drawing Pointing Device Image=1006) indicating whether the data currently being transferred is pointing device UI information. The (N+4) byte data 623 may be defined as a two-byte x-position of an image, a two-byte y-position of an image, and N-byte image data.

A command received through the command receiving unit 301 may be related to RUI information. If the received command is related to RUI information, the control unit 302 transfers information on the received command to the server 100 through the communication unit 303. Accordingly, when updated RUI information is received from the server 100 through the communication unit 303, the control unit 302 controls the display unit 304 to display the updated RUI information.

The server 100 of FIG. 1 may have a structure as illustrated in FIG. 7. FIG. 7 illustrates a block diagram showing another example of the server 100 of the network system of FIG. 1. Referring to FIG. 7, the server 100 includes a communication unit 701, an UI information generating unit 702, a control unit 703, and an event handling unit 704.

The communication unit 701 and the UI information generating unit 702 have the same structures and operations as the communication unit 201 and the UI information generating unit 202 of FIG. 2.

The event handling unit 704 provides the control unit 703 with event information corresponding to a key identifier (ID) included in information received through the communication unit 701. Thus, the event handling unit 704 can have event information corresponding to the key ID, which may be included in information received from the communication unit 701.

That is, when information is received through the communication unit 701 with the format of FIG. 5, the control unit 703 obtains corresponding event information from the event handling unit 704 based on a command ID, and obtains corresponding event information from the event handling unit 704 based on the key ID. For example, if the command ID includes “2001”, and the key ID includes “37”, then the control unit 703 transfers the command ID and the key ID to the event handling unit 704, and receives the corresponding key-down command and information on the left key as event information. As a result, the control unit 703 recognizes that information received from the client connected to the server 100 is generated by the key-down operation of the left key.

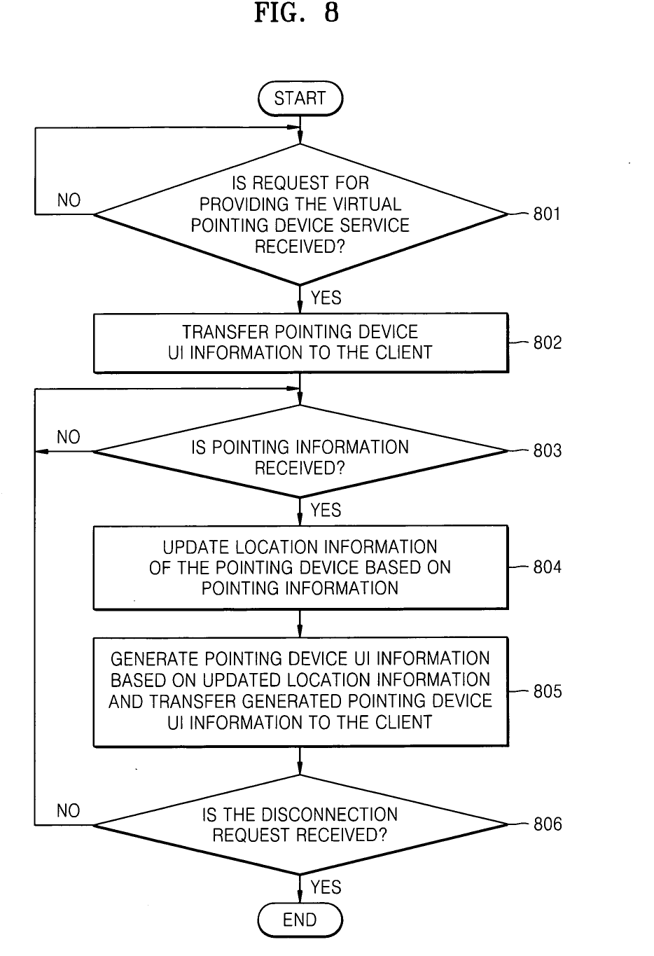

FIG. 8 is a flowchart illustrating a method of operating the server 100 of FIG. 1, according to an exemplary embodiment of the present invention.

The operation illustrated in FIG. 8 will be described with reference to FIG. 1. First, it is assumed that the client connected to the server 100 is the first client 120_1 from among the first and nth clients 120_1 to 120_{—}n. As illustrated in FIG. 1, the client connected to the server 100 is at least one of the first and nth clients 120_1 to 120_{—}n, that is, at least one of the clients included in the client group 120 included in a network system.

If a request for providing a virtual pointing device service is received from the first client 120_1, the server 100 transfers pointing device UI information to the first client 120_1 (operations 801 and 802).

If pointing information is received from the first client 120_1, the server 100 updates location information of the pointing device based on the received pointing information (operations 803 and 804). Next, the server 100 generates pointing device UI information based on the updated location information of the pointing device, and is transferred the pointing device UI information to the first client 120_1 (operation 805).

If a disconnection request is not received from the first client 120_1, the server 100 performs operation 803. Accordingly, the server 100 updates location information of the pointing device based on the received pointing information whenever pointing information is received from the first client 120_1. Furthermore, the server 100 generates pointing device UI information based on the updated location information of the pointing device whenever location information of the pointing device is updated, and transfers the generated pointing device UI information to the first client 120_1.

However, if the disconnection request is received from the first client 120_1, the server 100 ends a virtual pointing device service function for the first client 120_1 (operation 806).

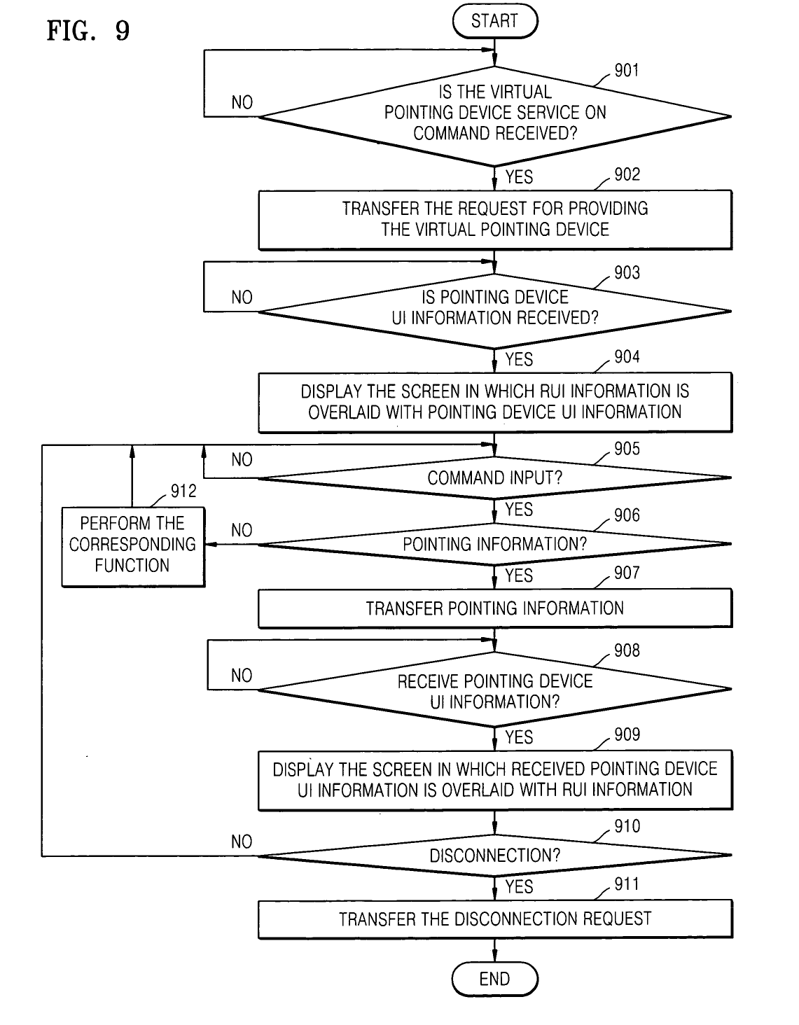

FIG. 9 illustrates a flowchart illustrating a method of operating the client, according to an embodiment of the present invention. The method of operating the client corresponds to the method of operating the server 100 in FIG. 8. The flowchart illustrated in FIG. 9 will be described with reference to FIG. 1. Like in FIG. 8, it is assumed that the client connected to the server 100 is the first client 120_1.

If a virtual pointing device service “on” command is received from the user of the first client 120_1, the first client 120_1 transfers a request for providing a virtual pointing device service to the server 100 (operations 901 and 902).

If pointing device UI information is received from the server 100, the first client 120_1 displays a screen in which the received pointing device UI information is overlaid with RUI information (operations 903 and 904). The RUI information is provided to the first client 120_1 from the server 100 after the server 100 and the first client 120_1 are connected to each other and before the virtual pointing device service on/off state is selected.

If a user command is input based on the screen displayed in operation 904, the first client 120_1 checks whether the input command is pointing information (operations 905 and 906). If the input command is pointing information, the first client 120_1 transfers input pointing information to the server 100 (operation 907). If pointing device UI information is received from the server 100, the first client 120_1 displays the screen in which the received pointing device UI information is overlaid with the RUI information (operations 908 and 909).

If the user inputs a disconnection command, the first client 120_1 transfers a disconnection request to the server 100 (operations 910 and 911). On the other hand, if the user does not input the disconnection command, the process returns to operation 905, and the input command is monitored from the displayed UI screen. In the displayed UI screen, RUI information is overlaid with pointing device UI information. According to the checked result obtained in operation 906, if the input command is not related to pointing device UI information, the first client 120_1 performs a function based on the input command, and the process returns to operation 905. In this case, the function based on the input command may include a function based on a command related to RUI information. If the input command is related to RUI information, the first client 120_1 transfers information based on the input command to the server 100. Accordingly, updated RUI information can be received from the server 100. When the updated RUI information is received, the displayed screen of the first client 120_1, in which RUI information is overlaid with pointing device UI information, is updated.

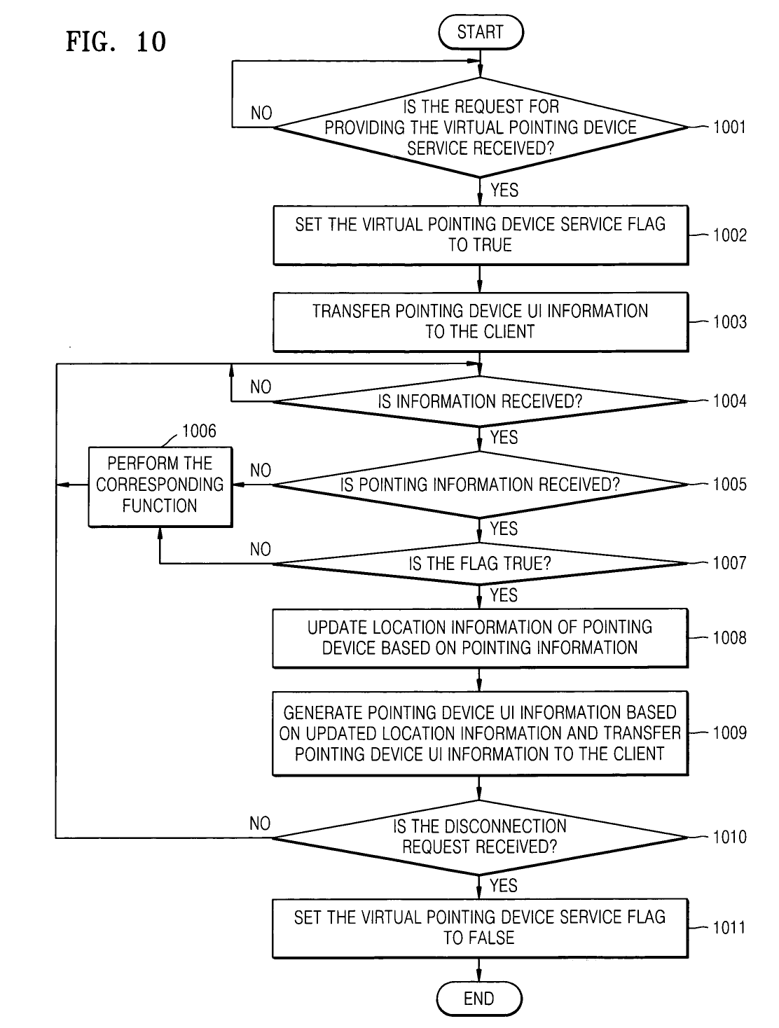

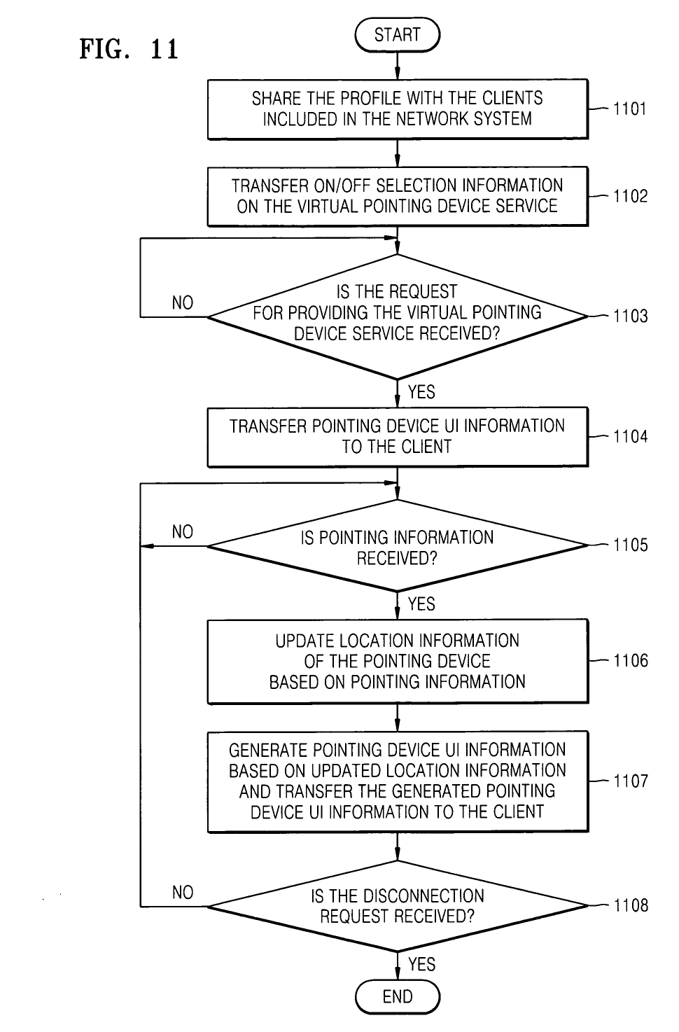

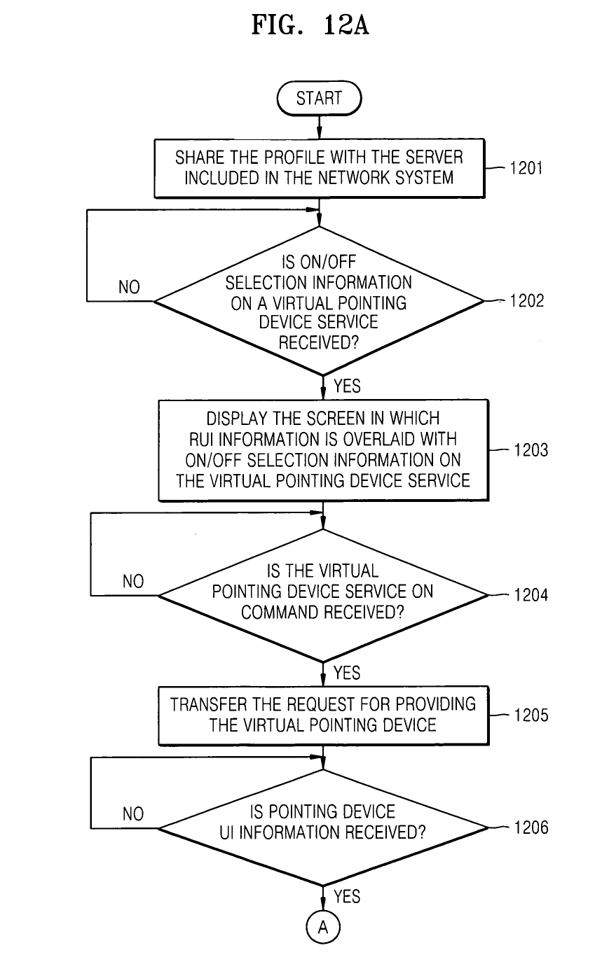

FIG. 10 illustrates a flowchart of a method of operating the server according to another exemplary embodiment of the present invention.

When the method of operating the server as illustrated in the flowchart in FIG. 10 is carried out in the same condition as the method of operating the server as illustrated in the flowchart in FIG. 8 and if a request for providing a virtual pointing device service is requested from the first client 120_1, the server 100 sets its virtual pointing device service flag to “True” (operations 1001 and 1002). This may be the same as generating a virtual pointing device service module by the server 100.

Next, the server 100 transfers pointing device UI information to the first client 120_1 (operation 1003). If information is received from the first client 120_1, the server 10 determines whether the received information is pointing information (operations 1004 and 1005). If the received information is not pointing information, the server 100 carries out a corresponding function (operation 1006), and then the server performs operation 1004.

In this case, if the received information is based on a command related to RUI information, and determines that RUI information needs to be updated, the server 100 updates RUI information in operation 1006, and transfers the updated RUI information to the first client 120_1.

If the received command is pointing information, the server 100 checks whether the virtual pointing device service flag is set to “True” (operation 1007). If the checked result indicates that the virtual pointing device service flag is not set to “True”, the server 100 performs operation 1006. In operation 1006, the server 100 searches for a function corresponding to the received pointing information from services provided to the first client 120_1 besides the virtual pointing device service, and if the corresponding function is found, the found function is carried out.

If the virtual pointing device service flag is set to “True”, the server 100 updates location information of the pointing device based on pointing information (operation 1008). Next, the server 100 generates pointing device UI information based on the updated location information of the pointing device and transfers the generated pointing device UI information to the first client 120_1 (operation 1009).

If a disconnection request is not received from the first client 120_1 and whenever pointing information is received from the first client 120_1, the server 100 performs operation 1004 so as to update location information of the pointing device based on the received pointing information, and whenever location information of the pointing device is updated, the server 100 generates pointing device UI information based on location information of updated location information of the pointing device (operation 1010) and transfers the generated pointing device UI information.

If the disconnection request is received from the first client 120_1 in operation 1010, the server 100 sets its virtual pointing device service flag to “False” (operation 1011). This may be the same as deleting a virtual pointing device service module generated in the server 100. Next, the server 100 ends the virtual pointing device service function for the first client 120_1.

The method of operating the client corresponding to the method of operating the server illustrated in FIG. 10 is the same as the method of operating the client illustrated in FIG. 9.

FIG. 11 is a flowchart illustrating a method of operating the server according to another exemplary embodiment of the present invention. Operations 1103 to 1108, but except for operations 1101 and 1102, are the same as operations 801 to 806 of the method of operating the server illustrated in FIG. 8.

The server 100 shares its profile with clients 120 connected with the server 100 (operation 1101). The client connected to the server 100 is included in a network system of the present invention, and is at least one of the first to nth clients 120_1 to 120_{—}n of FIG. 1.

In FIG. 11, it is assumed that the first client 120_1 is connected to the server 100 like in FIG. 8. The server 100 transfers virtual pointing device service on/off selection information to the first client 120_1 (operation 1102). In this case, virtual pointing device service on/off selection information may be transferred along with RUI information, or RUI information may be transferred before virtual pointing device service on/off selection information is transferred.

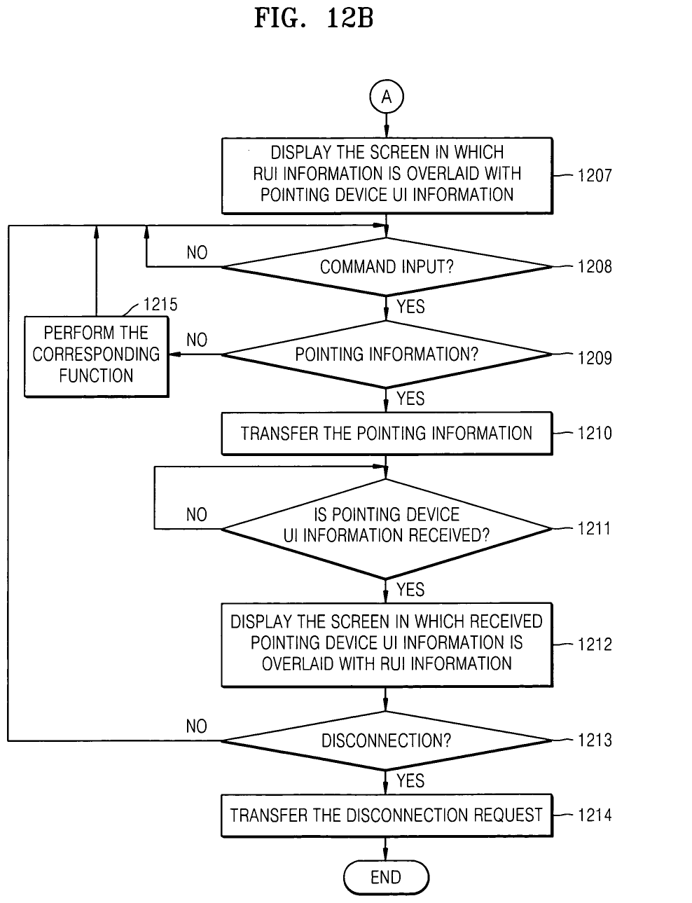

FIGS. 12A and 12B are flowcharts of a method of operating the client corresponding to the method of operating the server illustrated in FIG. 11, according to another embodiment of the invention.

Like in FIG. 11, operations 1204 to 1215 of the method of operating the client, but except for operations 1201 to 1203, are the same as operations 901 to 912 of the method of operating the client illustrated in FIG. 9.

The first client 120_1 shares its profile with the server 100 included in the network system (operation 1201). Next, if virtual pointing device service on/off selection information is received (operation 1202), the first client 120_1 displays a screen in which RUI information is overlaid with virtual pointing device service on/off selection information (operation 1203).

If a virtual pointing device service “on” command is received by using virtual pointing device service on/off selection information displayed on the screen (operation 1204), the first client 120_1 operates as illustrated in FIG. 9.

The server 100 of FIG. 1 provides an RUI service for a pointing device moving event that is generated from at least one of the clients 120 connected through the network 110.

To achieve this, when the server 100 and at least one of the clients 120 are connected through the network 110, the server 100 generates RUI information, and transfers the generated RUI information to the client connected to the server 100. In this case, RUI information generation performed by the server 100 may be defined as RUI capture since a plurality of RUI information that can be provided in the server 100 is prepared in advance, and corresponding RUI information from the prepared plurality of RUI information is captured. The RUI information to be transferred from the server 100 to the client connected to the server 100 may be transferred in the form of an image file by using a protocol such as external beam radiation therapy (XTR) or virtual network computing (VNC).

The connection between the server 100 and the clients may be carried out by the client group 120 using a uniform resource locator (URL) of the server 100 or a uniform resource identifier (URI) of the server 100. In addition, the clients 120 are connected to the server 100, which may be carried out by using a method defined by RUI, such as a digital living network alliance (DLNA) V2, a consumer electronics association (CEA) working group (WG) 7.9, or the like, according to a two-box or three-box model defined by the Universal Plug and Play (UPnP) protocol.

If the pointing device moving event and location information corresponding thereto are received from the client connected to the server 100 after RUI information is transferred to the client connected to the server 100, the server 100 generates RUI information based on the received pointing device moving event and location information corresponding thereto. That is, the server 100 captures RUI information based on the pointing device moving event and location information corresponding thereto.

The server 100 transfers the generated RUI information to the client connected to the server 100. In this case, the server 100 may check whether the RUI service corresponding to the received pointing device moving event exists. For example, when the server 100 can provide a rollover service or a highlight service based on the pointing device moving event, the server 100 can check whether the received pointing device moving event corresponds to services that can be provided by the server 100. If the received pointing device moving event corresponds to the RUI service that can be provided by the server 100, the server 100 generates RUI information corresponding to the received pointing device moving event, and transfers the generated RUI information to the client connected to the server 100.

When an event besides the pointing device moving event and location information corresponding thereto are received, the server 100 generates RUI information based on the received event, and transfers the generated RUI information to the client connected to the server 100.

If disconnection is requested from the client connected to the server 100, the server 100 ends the RUI service function for the client connected to the server 100.

All, some, or any one of the first to nth clients 120_1 to 120_{—}n may be connected to the server 100 so as to provide the RUI services for the pointing device-moving service and an event, besides the pointing device-moving service, which are provided by the server 100.

If pointing devices (not shown) do not move for a predetermined time, the first to nth client 120_1 and 120_{—}n generate a pointing device moving event for a position where each of the pointing devices has stopped moving.

The network 110 carries out a connection between the server 100 and the clients 120 by using a method defined by RUI, such as, the DLNA V2, the CEA WG 7.9, or the like, according to a two-box or three-box model defined by the UPnP protocol. The network 110 can send or receive information between the server 100 and the clients 120 based on the RUI protocol.

To achieve the aforementioned operations, the server 100 may have the structure of FIG. 13. FIG. 13 is a block diagram showing another example of the server 100 of FIG. 1. Referring to FIG. 13, the server 100 includes a communication unit 1301, an RUI information generating unit 1302, and a control unit 1303.

The communication unit 1301 sends or receives information between the server 100 and at least one of the first to nth clients 120_1 to 120_{—}n. The RUI information generating unit 1302 generates RUI information for a pointing device moving event. The RUI information generating unit 1302 may generate more RUI information of an event besides the above pointing device moving event.

When the client connected to the server 100 is connected to the server 100 through the network 110, the control unit 1303 transfers RUI information to the client connected to the server 100. As a result, when a pointing device moving event and location information corresponding thereto are received from the client connected to the server 100, the control unit 1303 controls RUI information generating unit 1302 to generate RUI information based on the received pointing device moving event. The control unit 1303 transfers the generated RUI information to the client connected to the server 100 by using the communication unit 1301.

When an event besides the pointing device moving event and location information corresponding thereto are received, the control unit 1303 controls RUI information generating unit 1302 to generate RUI information based on the received event. The control unit 1303 transfers the generated RUI information to the client connected to the server 100.

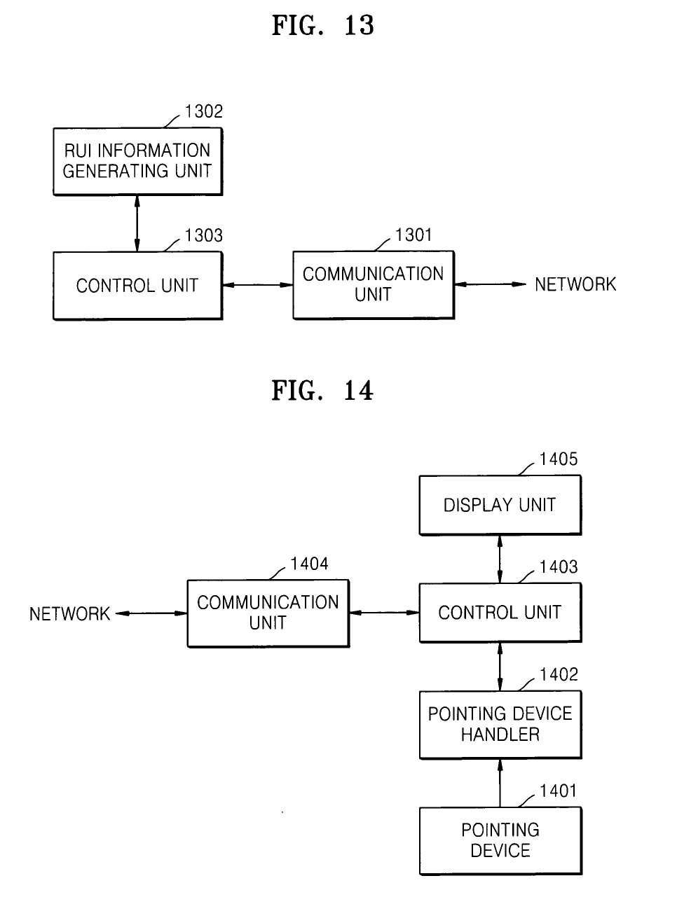

The client connected to the server 100 in FIG. 1 may have a structure as illustrated in FIG. 14. Likewise, the first to nth clients 120_1 to 120_{—}n of FIG. 1 may have the structure as illustrated in FIG. 14. FIG. 14 is a block diagram showing another example of the first to nth clients 120_1 to 120_{—}n of FIG. 1. Referring to FIG. 14, the client connected to the server 100 includes a pointing device 1401, a pointing device handler 1402, a control unit 1403, a communication unit 1404, and a display unit 1405.

The pointing device 1401 is a command input device such as a mouse.

The pointing device handler 1402 monitors the operation of the pointing device 1401, and provides the monitoring result to the control unit 1403.

In particular, if the pointing device handler 1402 detects that the pointing device has stopped operating for a predetermined time while monitoring the operation of the pointing device 1401, the pointing device handler 1402 generates a pointing device moving event to be transferred to the control unit 1403. The pointing device handler 1402 may generate a pointing event to be transferred to the control unit 1402 by monitoring the operation of the pointing device 1401. The pointing event may be generated by a choice of a user who uses the pointing device 1401.

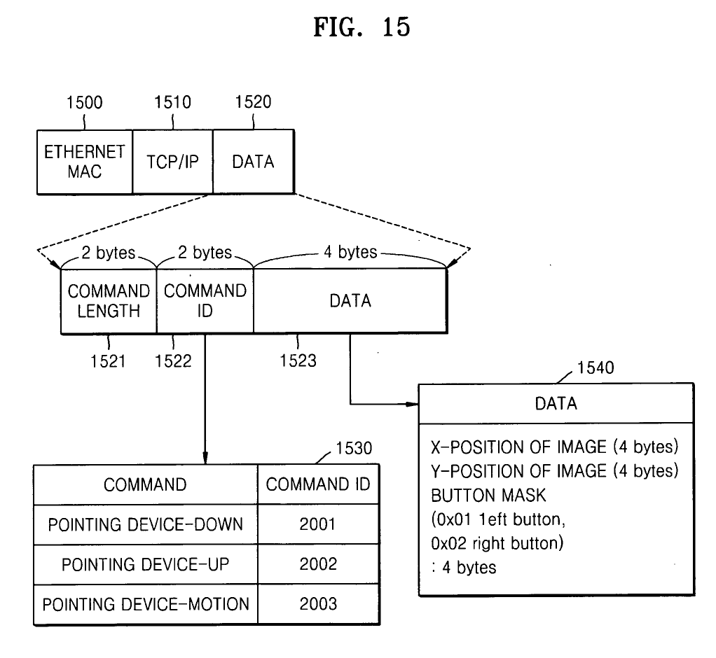

When the pointing device moving event is generated from the pointing device handler 1402, the control unit 1403 transfers the generated pointing device moving event and location information corresponding thereto to the server 100 through the communication unit 1404. In this case, the transferred data may have the format as illustrated in FIG. 15.

FIG. 15 illustrates a data format of data transferred to the server 100 from the client connected to the server 100, according to an exemplary embodiment of present invention.

In FIG. 15, the data is transferred to the server 100 from the client connected to the server 100 by using a TCP based packet transfer method. This can be realized according to information defined in a field 1500 and a field 1510.

Referring to FIG. 15, each data field 1520 includes a 2-byte command length 1521, a 2-byte command ID 1522, and 4-byte data 1523. The 2-byte command ID 1522 may represent a pointing device down (pointing device-down, mouse-down, or key-down) command, a pointing device up (pointing device-up, mouse-up, or key-up) command, or a pointing device move (pointing device-move, mouse-move, or key-move) command. The pointing device move command indicates that a pointing device moving event is generated as the pointing device 1401 has stopped moving for a predetermined time. The pointing device down command and the pointing device up command are used for the server 100 to distinguish a continuous input value. When the pointing device moving event is generated, data may include an x-coordinate value of the location where the pointing device 1401 has stopped moving (or x-position of an image), a y-coordinate value of the location where the pointing device 1401 has stopped moving (or y-position of an image), or button mask information which indicates whether a right or left button is pressed of the pointing device 1401 such as a mouse.

The pointing device moving event is generated when the display unit 1405 displays an RUI screen. Thereafter, if RUI information is received from the server 100, the control unit 1403 controls the display unit 1405 to display the RUI screen based on the received RUI information. As a result, the RUI screen displayed by the display unit 1405 is updated.

The communication unit 1404 is used for data communication between the server 100 and the client connected to the server 100. The display unit 1405 displays the RUI screen under the control of the control unit 1403.

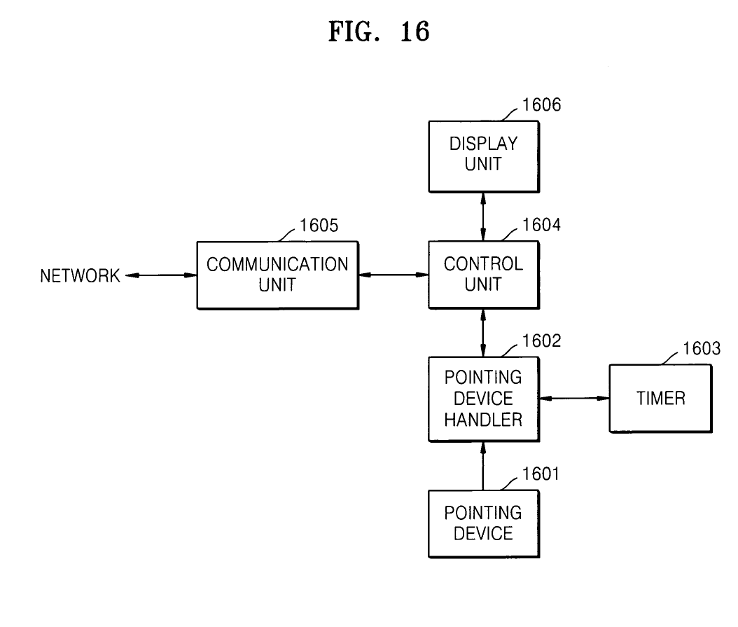

The client connected to the server 100 may have the structure of FIG. 16. Therefore, the first to nth clients 120_1 to 120_{—}n of FIG. 1 may have the structure as illustrated in FIG. 16.

FIG. 16 is a block diagram showing another example of the first to nth clients of the network system of FIG. 1. Referring to FIG. 16, a client connected to the server 100 includes a pointing device 1601, a pointing device handler 1602, a timer 1603, a control unit 1604, a communication unit 1605, and a display unit 1606.

The pointing device 1601, the control unit 1604, the communication unit 1605, and the display unit 1606 have the same structures and operations as the pointing device 1401, the control unit 1403, the communication unit 1404, and the display unit 1405 illustrated in FIG. 14.

The pointing device handler 1602 monitors the operation of the pointing device 1601. If the monitoring result indicates that the pointing device 1601 has stopped moving, the pointing device handler 1602 operates the timer 1603 from that moment.

The timer 1603 starts to measure a time when the pointing device handler 1602 starts its operation. The pointing device handler 1602 monitors whether the pointing device 1601 moves, and also monitors the time measured by the timer 1603. If the monitoring result indicates that a predetermined time elapses after the pointing device 1601 has stopped moving, a pointing device moving event is generated and transferred to the control unit 1604. When the pointing device moving event is generated, the pointing device handler 1602 resets the time measured by the timer 1603. The predetermined time is set in advance. The predetermined time may be 0.5 second.

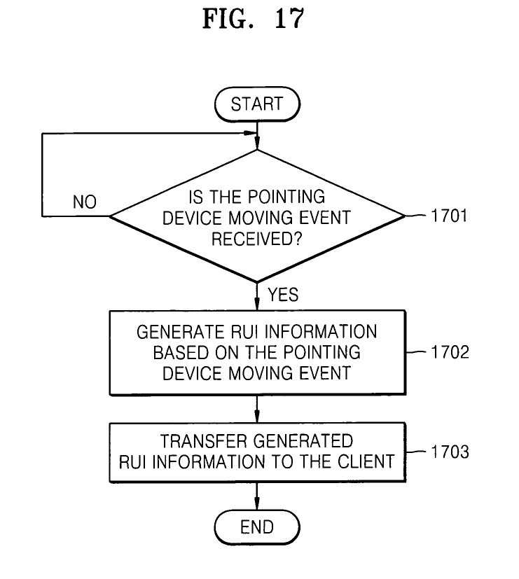

FIG. 17 is a flowchart illustrating a method of operating the server according to another exemplary embodiment of the present invention. The method of operating the server illustrated in FIG. 17 will be described with reference to FIG. 1.

First, it is assumed that the client connected to the server 100 is the first client 120_1 from among the clients 120. As illustrated in FIG. 1, the client connected to the server 100 is at least one of the first and nth clients 120_1 to 120_{—}n, that is, at least one of the clients 120 included in the network system.

If a pointing device moving event is received from the first client 120_1, the server 100 generates RUI information based on the received pointing device moving event and corresponding location information (operations 1701 and 1702). In this case, the RUI information generation may be represented by RUI information capture. If RUI information is generated, the server 100 transfers the generated RUI information to the first client 120_1 (operation 1703). The generated RUI information may be defined by updated RUI information.

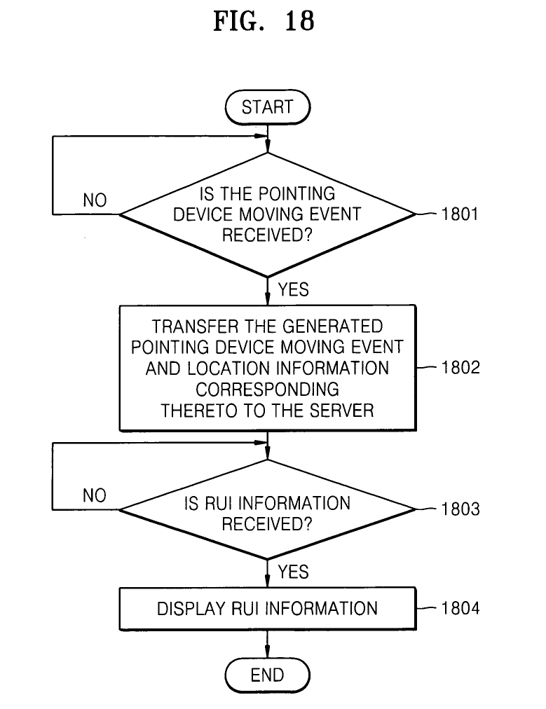

The operation method of the first client 120_1 corresponding to the operation method of the server 100 is shown in FIG. 18. FIG. 18 is a flowchart of the method of operating the client, according to another exemplary embodiment of the present invention.

Now, the flowchart of the method of operating the client as illustrated in FIG. 18 will be described with reference to FIG. 1. Like in FIG. 17, it is assumed that the client connected to the server 100 is the first client 120_1.

If a pointing device moving event is generated by the first client 120_1, the generated pointing device moving event and location corresponding to the generated pointing device moving event are transferred to the server 100 (operations 1801 and 1802).

Thereafter, if RUI information based on the pointing device moving event is received from the server 100, the first client 120_1 displays the received RUI information (operations 1803 and 1804). The display of RUI information in operation 1804 may be defined as an update of RUI information. This is because the pointing device moving event may be generated in operation 1801 while RUI information is displayed.

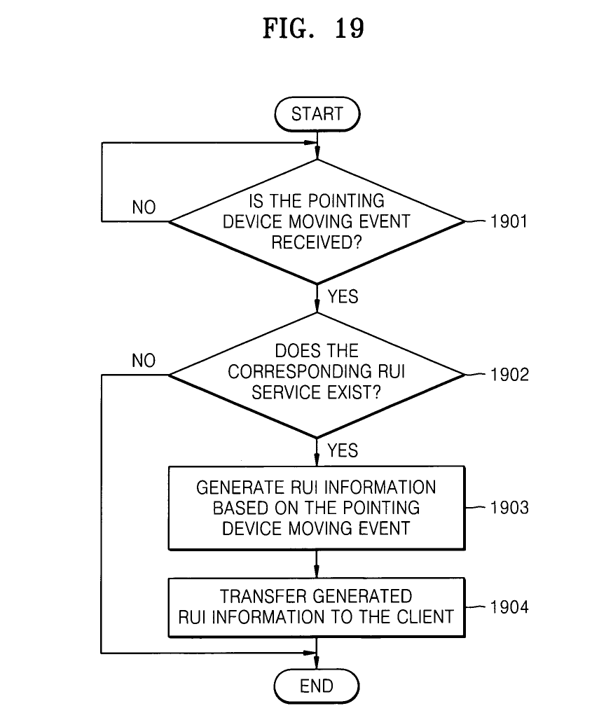

FIG. 19 is a flowchart illustrating a method of operating the server according to another exemplary embodiment of the present invention. It is assumed that the method of operating the server as illustrated in FIG. 19 is carried out in the same condition as the method of operating the server as illustrated in FIG. 17. If a pointing device moving event is received from first client 120_1, the server 100 checks whether an RUI service exists which corresponds to the received pointing device moving event from the RUI services that can be provided by the server 100 (operations 1901 and 1902). For example, when the server 100 can provide a rollover service or a highlight service based on the pointing device moving event, the server 100 can check whether the received pointing device moving event provides the rollover service or the highlight service.

If the checked result indicates that the RUI service corresponding to the received pointing device moving event exists in server 100, the server 100 generates RUI information based on the pointing device moving event, and transfers the generated RUI information to the first client 120_1 (operations 1903 and 1904). On the other hand, if the checked result in operation 1902 indicates that the RUI service corresponding to the received pointing device moving event does not exist in the server 100, the server 100 does not generate RUI information based on the pointing device moving event nor transfers RUI information, but ends the operation for the received pointing device moving event.

If RUI information is not generated, and thus RUI information is not transferred, the server 100 does not transfer any information to the first client 120_1. Therefore, even if the pointing device moving event is generated, the RUI screen displayed thereby is not updated in the first client 120_1. In this case, the sever 100 may indicate that the RUI service for a corresponding pointing device moving event does not exist.

When the server 100 operates as illustrated in FIG. 19, operation 1803 of FIG. 18 performed in the first client 120_1 may be modified such that the process is ended when RUI information is not received.

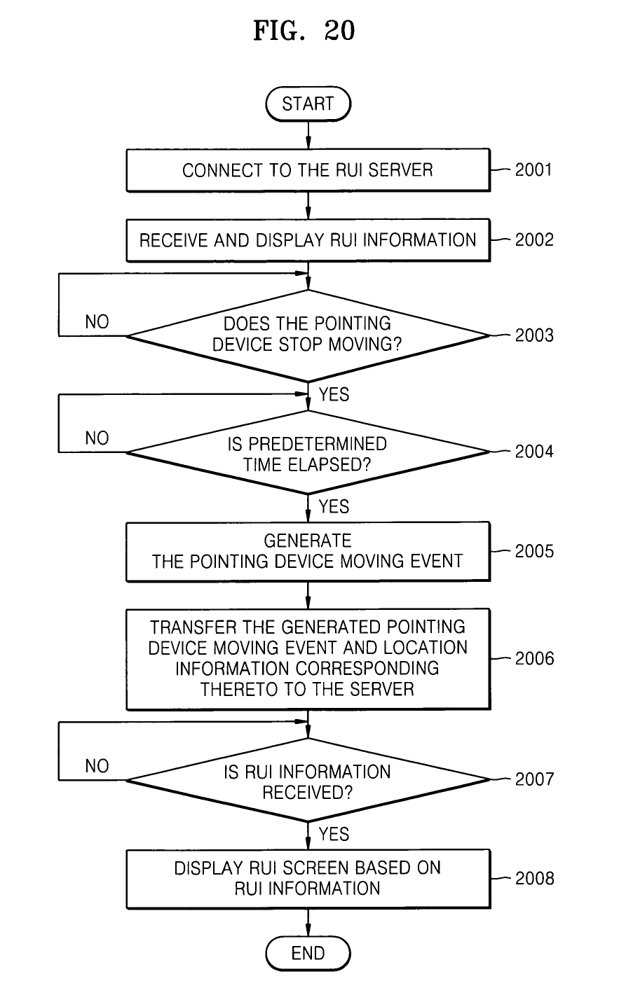

FIG. 20 is a flowchart illustrating a method of operating the client according to another exemplary embodiment of the present invention. The first client 120_1 is connected to the server as in the method of operating the server 100 illustrated in FIG. 17.

The first client 120_1 is connected to the server 100 illustrated in FIG. 1 (operation 2001). The server 100 may be defined as an RUI server.

If RUI information is received from the server 100 after the first client 120_1 is connected to the server 100, the first client 120_1 checks whether a pointing device of the first client 120_1 has stopped moving (operations 2002 and 2003).

If the checked result indicates that the pointing device has stopped moving, the server 100 checks whether a predetermined time has elapsed after the pointing device has stopped moving (operation 2004). If the predetermined time is determined to have elapsed after the pointing device has stopped moving, the first client 120_1 generates a pointing device moving event (operation 2005).

Thereafter, the generated pointing device moving event and location information corresponding to the generated pointing device moving event are transferred to the server 100 (operation 2006). If RUI information is received from the server 100 (operation 2007), the first client 120_1 displays an RUI screen based on the received RUI information (operation 2008). Accordingly, the RUI screen displayed by the first client 120_1 is updated.

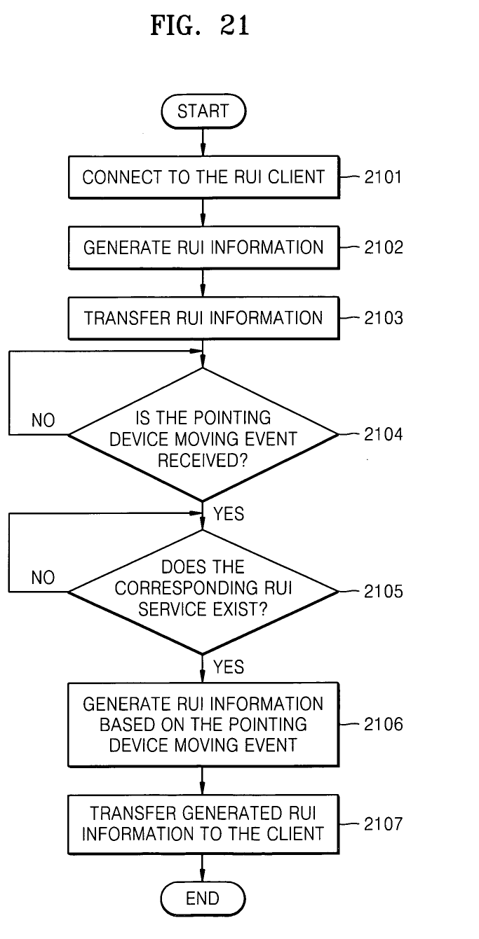

FIG. 21 is a flowchart illustrating a method of operating the server when the first client 120_1 operates as illustrated in FIG. 20, according to another exemplary embodiment of the present invention.

The first client 120_1 is connected to the server 100 through the network 110 illustrated in FIG. 1 (operation 2101). The first client 120_1 may be defined as an RUI client.

When the first client 120_1 is connected to the server 100, the server 100 generates RUI information (operation 2102). The generated RUI information is transferred to the first client 120_1 (operation 2103). Thereafter, if a pointing device moving event is received from the first client 120_1 (operation 2104), the server 100 checks whether an RUI service exists which corresponds to the pointing device moving event currently being received from the RUI services that can be provided by the server 100 (operation 2105).

If the checked result indicates that the RUI service corresponding to the pointing device moving event currently being received exists, the server 100 generates RUI information based on the pointing device moving event (operation 2106). Thereafter, the server 100 transfers the generated RUI information to the first client 120_1 (operation 2107). As a result, the first client 120_1 updates an RUI screen displayed as illustrated in FIG. 20, based on the received RUI information.

According to the exemplary embodiments of the present invention, in a network based on a remote user interface (RUI) protocol, a virtual pointing device service is provided between an RUI client and an RUI server. Thus, an input device (e.g. a remote control) of the RUI client can be used as a pointing device without having to add an additional function to the RUI client that does not support the pointing device function.

In addition, the RUI client included in the network based on the RUI protocol shares not only a pointing event but also an RUI service that is supported by the RUI server for the pointing device moving event, thereby extending an RUI service range for the pointing device that can be supported by the RUI client.

For example, an advanced RUI service for the pointing device, such as a rollover service or a highlight service which are supported by the RUI server and are based on a pointing device moving event can be shared with the RUI client.

In addition, the RUI client generates a pointing device moving event at a coordinate where the pointing device has stopped moving for a predetermined time, thereby preventing the waste of network resources when the pointing device moving event is unnecessarily generated.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A network system based on a remote user interface protocol, the network system comprising:
a plurality of clients; and
a server which transfers pointing device user interface information to at least one of the clients if a request for providing a virtual pointing device service is transferred from the at least one of the clients.

2. The network system of claim 1, wherein, if pointing information is received from the at least one of the clients, the server updates location information of a pointing device based on the received pointing information, generates pointing device user interface information based on the updated location information of the pointing device, and transfers the generated pointing device user interface information to the at least one of the clients.

3. The network system of claim 2, wherein, after a profile is shared between the at least one of the clients and the server, the server transfers virtual pointing device service on/off selection information to the at least one of the clients.

4. The network system of claim 3, wherein, if a disconnection is requested from a client that provides the virtual pointing device service, the server ends a virtual pointing device service function for the client requesting the disconnection.

5. The network system of claim 1, wherein, after the profile is shared between the at least one of the clients and the server, the server transfers virtual pointing device service on/off selection information to the at least one of the clients.

6. The network system of claim 1, wherein the server comprises:
a user interface information generating unit which generates pointing device user interface information;
a communication unit which is communicably linked to at least one of the clients; and
a control unit which controls the user interface information generating unit to generate the pointing device user interface information, and transfers the generated pointing device user interface information to the communication unit, if the request for providing the virtual pointing device service is received from the communication unit.

7. The network system of claim 5, wherein each of the clients comprises:
a command receiving unit which receives a user command;
a communication unit which is communicably linked to the server;
a display unit which displays a pointing device user interface screen based on pointing device user interface information; and
a control unit which transfers the request for providing the virtual pointing device service to the communication unit, and controls the display unit to display the pointing device user interface screen if pointing device user interface information is received from the communication unit.

8. The network system of claim 1, wherein each of the clients comprises:
a command receiving unit which receives a user command;
a communication unit which is communicably linked to the server;
a display unit which displays a pointing device user interface screen based on pointing device user interface information; and
a control unit which transfers the request for providing the virtual pointing device service to the communication unit, and controls the display unit to display the pointing device user interface screen if pointing device user interface information is received from the communication unit.

9. A server for providing a virtual pointing device service in a network system which is based on a remote user interface protocol and includes a plurality of clients, the server comprising:
a user interface information generating unit which generates at least pointing device user interface information;
a communication unit which is communicably linked to at least one of the clients; and
a control unit which controls the user interface information generating unit to generate pointing device user interface information, and transfers the generated pointing device user interface information to the communication unit, if a request for providing the virtual pointing device service is received from the communication unit.

10. The server of claim 9, wherein, after a profile is shared between the at least one of the clients and the server, the control unit transfers virtual pointing device service on/off selection information to the at least one of the clients through the communication unit.

11. The server of claim 9, wherein, if pointing information is received from the at least one of the clients, the control unit updates location information of a pointing device based on the received pointing information, generates pointing device user interface information based on the updated location information of the pointing device, and transfers the generated pointing device user interface information to the at least one of the clients.

12. The server of claim 9, wherein the server further comprises an event handling unit which provides event information corresponding to key identification information included in information received from the communication unit to the control unit.

13. The server of claim 9, wherein the user interface information generating unit further generates remote user interface information.

14. A client which can provide a virtual pointing device service in a network system which is based on a remote user interface protocol and includes a server which can provide the virtual pointing device service, the client comprising:
a command receiving unit which receives a user command;
a communication unit which is communicably linked to the server;
a display unit which displays a pointing device user interface screen based on pointing device user interface information; and
a control unit which transfers a request for providing the virtual pointing device service to the communication unit, and controls the display unit to display the pointing device user interface screen if pointing device user interface information is received from the communication unit.

15. The client of claim 14, wherein, if pointing device user interface information is received, the control unit controls the display unit to display a screen in which remote user interface information is overlaid with pointing device user interface information.

16. A method of operating a server for a virtual pointing device service in a network system including a server and a plurality of clients, the method comprising:
transferring pointing device user interface information to at least one of the clients if a request for providing a virtual pointing device service is received from the at least one of the clients;
updating location information of a pointing device based on pointing information if pointing information is received from the at least one of the clients; and
generating pointing device user interface information based on updated location information of the pointing device, and transfers the generated pointing device user interface information to the at least one of the clients, if location information of the pointing device is updated.

17. The method of claim 16, further comprising, if a disconnection is requested from a client requesting the virtual pointing device service, ending a virtual pointing device service function for the client.

18. The method of claim 16, further comprising, after a profile is shared between the at least one of the clients and the server, transferring virtual pointing device service on/off selection information to the at least one of the clients.

19. A method of operating a client for a virtual pointing device service in a network system including a server and a plurality of clients, the method comprising:
transferring a request for providing a virtual point device service to the server;
displaying a screen in which pointing device user interface information is overlaid with remote user interface information if pointing device user interface information is received from the server;
transferring a command to the server when the command is input based on the displayed screen; and
displaying user interface information received from the server based on the input command.

20. The method of claim 19, wherein the transferring of the request for a providing the virtual pointing device service to the server is performed by selecting “on” from the virtual pointing device service on/off selection received from the server after a profile is shared between the server and the clients.

21. A computer-readable medium having embodied thereon a computer program for executing a method of operating a server for a virtual pointing device service in a network system including a server and a plurality of clients, the method comprising:
transferring pointing device user interface information to at least one of the clients if a request for providing a virtual pointing device service is received from the at least one of the clients;
updating location information of a pointing device based on pointing information if pointing information is received from the at least one of the clients; and
generating pointing device user interface information based on updated location information of the pointing device, and for transferring the generated pointing device user interface information to the at least one of the clients, if location information of the pointing device is updated.

22. A computer-readable medium having embodied thereon a computer program for executing a client operation method for a virtual pointing device service in a network system including a server and a plurality of clients, the method comprising:
transferring a request for a providing a virtual pointing device service to the server;
displaying a screen in which pointing device user interface information is overlaid with remote user interface information if pointing device user interface information is received from the server;
transferring a command to the server if the command is input based on the displayed screen; and
displaying user interface information received from the server based on the input command.

23. A network system based on a remote user interface protocol, the network system comprising:
a plurality of clients; and
a server which generates remote user interface information based on a pointing device moving event and corresponding location information, and transfers the generated remote user interface information to at least one of the clients, if the pointing device moving event and location information corresponding thereto are received from the at least one of the clients.

24. The network system of claim 23, wherein, if an event besides the pointing device moving event and corresponding location information are received from the at least one of the clients, the server generates remote user interface information based on the received event, and transfers the generated remote user interface information to the at least one of the clients.

25. The network system of claim 23, wherein the server comprises:
a user interface information generating unit which generates remote user interface information for the pointing device moving event;
a communication unit which is communicably linked to the at least one of the clients; and
a control unit which controls a remote user interface information generating unit to generate remote user interface information based on the pointing device moving event, and transfers generated remote user interface information to the communication unit, if the pointing device moving event and location information corresponding thereto are received from the communication unit.

26. The network system of claim 23, wherein the clients generate a pointing device moving event for a position where the pointing device has stopped moving if the pointing device of the clients does not move for a predetermined time.

27. The network system of claim 23, wherein each of the clients comprises:
a pointing device;
a communication unit which is communicably linked to the server the server;
a display unit which displays a remote user interface screen;
a pointing device handler which monitors the pointing device and generates the pointing device moving event; and
a control unit which transfers the pointing device moving event and location information corresponding to the server through the communication unit when the pointing device moving event is generated from the pointing device handler, and controls the display unit to display the remote user interface screen based on remote user interface information if remote user interface information is received from the server.

28. A server which can provide a remote user interface service in a network system which is based on a remote user interface protocol and includes a plurality of clients, the server Comprising:
a user interface information generating unit which generates remote user interface information;
a communication unit which is communicably linked to at least one of the clients; and
a control unit which controls the remote user interface information generating unit to generate remote user interface information based on the pointing device moving event, and transfers the generated remote user interface information to the communication unit, if the pointing device moving event and location information corresponding thereto are received from the communication unit.

29. The server of claim 28, wherein, if an event besides the pointing device moving event and location information corresponding thereto are received, the control unit controls the remote user interface information generating unit to generate remote user interface information based on the received event, and transfers the generated remote user interface information to the at least one of the clients.

30. A client which can provide a remote user interface service in a network which is based on a remote user interface protocol and includes a server which can provide the remote user interface service, the client comprising:
a pointing device;
a communication unit which is used for communication between the server and the client;
a display unit which displays a remote user interface screen;
a pointing device handler which monitors the pointing device and generates a pointing device moving event; and
a control unit which transfers the pointing device moving event and location information corresponding to the server through the communication unit if the pointing device moving event is generated from the pointing device handler, and controls the display unit to display the remote user interface screen based on remote user interface information if remote user interface information is received from the server.

31. The client of claim 30, wherein, if the pointing device has stopped moving for a predetermined time, the pointing device handler generates the pointing device moving event at a position where the pointing device has stopped moving.

32. The client of claim 30, wherein the client further comprises a timer which operates if the pointing device has stopped moving, and
wherein the pointing device handler drives the timer if the pointing device has stopped moving, and monitors whether a time measured by the timer reaches the predetermined time.

33. A method of operating a server for a remote user interface service in a network system including a server and a plurality of clients, the method comprising:
generating remote user interface information based on a pointing device moving event and corresponding location information if the pointing device moving event is received from at least one of the clients; and
transferring the generated remote user interface information to the at least one of the clients.

34. The method of claim 33, wherein the generating of the remote user interface information comprises:
checking whether a remote user interface service corresponding to the pointing device moving event exists in the server if the pointing device moving event is received; and
generating remote user interface information based on the pointing device moving event if the remote user interface service corresponding to the pointing device moving event exists in the server.

35. A method of operating a client for a remote user interface service in a network system including a server and a plurality of clients, the method comprising:
transferring a pointing device moving event and location information corresponding to the server if the pointing device moving event of the client is generated, and
displaying remote user interface information based on the received remote user interface information if remote user interface information is received from the server.

36. The method of claim 35, wherein, if the pointing device of the client has stopped moving for a predetermined time, the pointing device moving event is generated at a position where the pointing device has stopped moving.

37. A computer-readable medium having embodied thereon a computer program for executing a server operation method for a remote user interface service in a network system including a server and a plurality of clients, the method comprising:
generating remote user interface information based on a pointing device moving event and corresponding location information if the pointing device moving event is received from at least one of the clients; and
transferring the generated remote user interface information to the at least one of the clients.

38. A computer-readable medium having embodied thereon a computer program for executing a client operation method for a remote user interface service in a network system including a server and a plurality of clients, the method comprising:
transferring a pointing device moving event and corresponding location information to the server if the pointing device moving event of the client is generated, and
displaying remote user interface information based on the received remote user interface information if remote user interface information is received from the server.
